(19) United States
(12) Patent Application Publication
(10) Pub. No.: US 2004/0246439 A1
(43) Pub. Date: Dec. 9, 2004

(54) Refractive adapter for close-range viewing, with devices for rotating corrective lens housed in spectacle frames

(76) Inventor: Piero Petroccione, Fontanarosa (IT)

Correspondence Address: Breiner & Breiner, 115 North Henry Street, PO Box 19290, Alexandria, VA, 22320-0290, US

(21) Appl. No.: 10/491,731

(22) PCT Filed: Oct. 8, 2002
(86) PCT No.: PCT/IT02/00640

(30) Foreign Application Priority Data
Oct. 10, 2001 (IT) AV01A000006

(51) Int. Cl. G02C 7/02

(52) U.S. Cl. 351/176

(57) ABSTRACT

A refractive adapter for correcting accomodation disorders caused by prolonged exposure to video terminals or work involving minute objects and for helping to reduce eye strain caused by excessive visual stress at work or in leisure activites. The system comprises rotating corrective lens of various stengths, to be used as required, housed inside the spectacle frame. Rotation occurs by apllying pressure with a fingertip on the projecting lens housed in the frame slots, or by friction of a motor, consisting of a bearin with an outer surface in plastic to ensure a high friction coefficient with the moving body. The controls may be either mechanical (powered with a touch of the finger) or electromechanical (powered by a light source). The system may be an actual spectacle frame with mounted lens or a device apllied to an existing frame.

### TECHNICAL FIELD

This invention relates to a device for helping the eye to adapt during prolonged work at videoterminals, which feature intensive light radiation from the monitor screens; and for correcting eye strain due to visual stress at work or in leisure activities.

### BACKGROUND OF ART

The causes of eye strain are many and not all easily identifiable; generally speaking, they may be broken down into enviromental, ocular and systemic causes.

Among the enviromental causes there are insufficient and bad lighting and visual field defects, such as the capacity to measures details (very small print, miniature objects in the electronics and other industries), limited contrast (many modern print types), rythmic or continues movements (chain processes, reading while travelling).

Secondly, eye strain may be due to ocular (or eye-related) causes, such as non-corrected ametropias, phoria, convergence and merging deficits, aniseiconia and, aboveall, accomodation disorders, wherefore it is very important that the person concerned be allowed to indipendently find the lens beat suited to his or her working/leisure conditions, based on distance and especially eye accomodation. This is particularly the case with regard to computers, where the proposed invention has a widespread application potential; monitor glare filters, in fact, are insufficient, while spectacles with variable lens that can be changed/adapted according to the individual, the distance and the time spent in front of a monitor unquestionably represent a major breakthrough.

This refractive adapter allows videoterminal operators to accurately focus by helping the eye in its natural accomodation process.

Unlike conventional fixed-lens spectacles, the invention allows a range of focusing distances and compared with bifocal and progressive lens it ensures enhanced tolerance, especially with computers.

This is why the device may be used as a valid alternative to bifocal and progressive lens for correcting presbyopia.

Furthermore, the special device mounted in the frame is a valid alternative for all those who, having crossed the forty years mark when the crystalline lens (presbyopia) starts ageing, are obliged to using reading glasses, or for individuals who are obliged to use more than one plair of glasses because they are affected by different disorders.

### EXAMPLE

A specific embodiment of the invention will now be described by way of example with reference to the accompanying drawing in which:

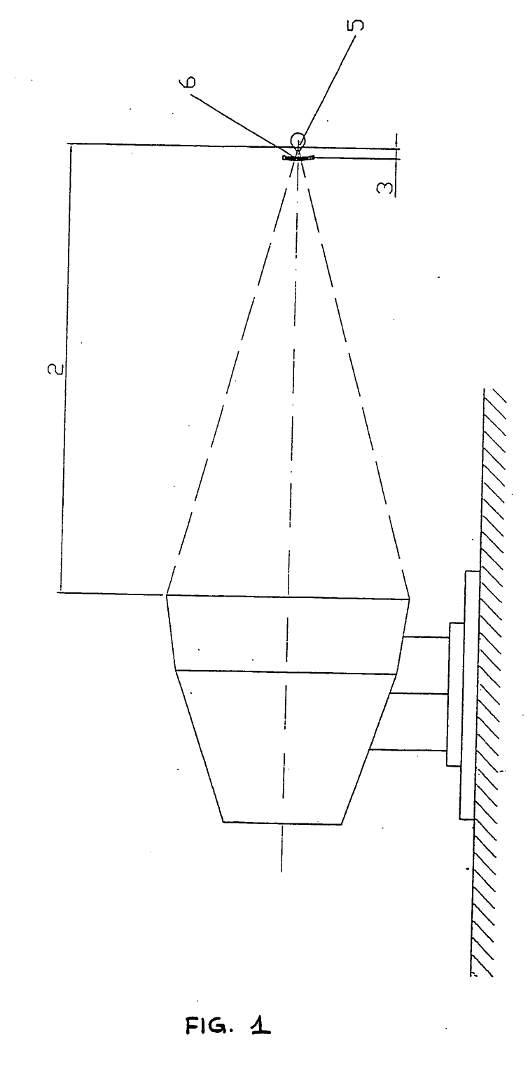

FIG. 1 shows the starting point of the study, where: (2) is the distance netween the cornea (5) of the oerator and the monitor screen (assumed to be a 19″ monitor), with (2)=60 cm; and

(3) is the distance between the cornea and the lens (6), with 12 mm≦(3)≦14 mm.

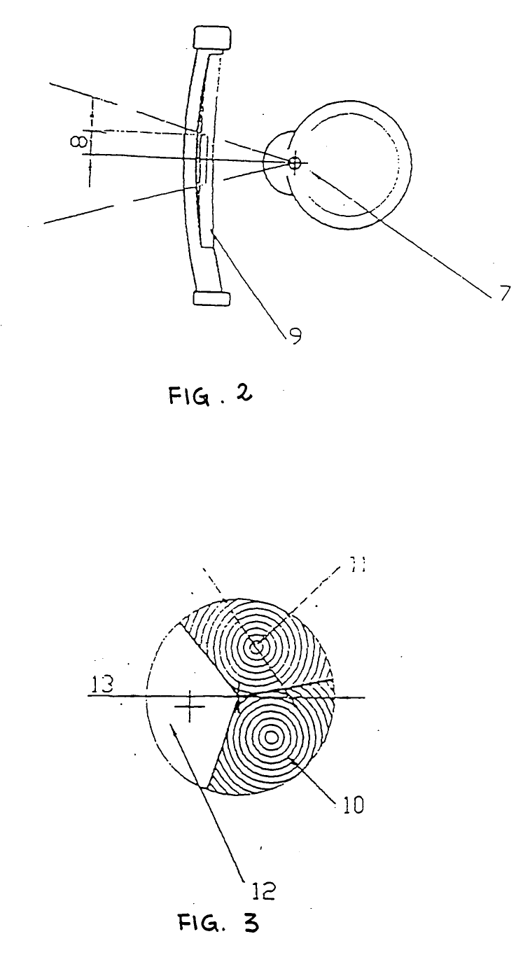

FIG. 2 shows the solid angle with apex in the pupil (7) and sufficient to enclose the screen at the distance (2), this produces the minimum radius (8) of the corrective surface. The drawing also shows the lens (9) containing the three different refractive areas.

FIG. 3 shows a front view of the lens (9) with diameter (13), featuring three different refractive surfaces with differing strength, (10), (11) and (12) respectively, with diameter (14).

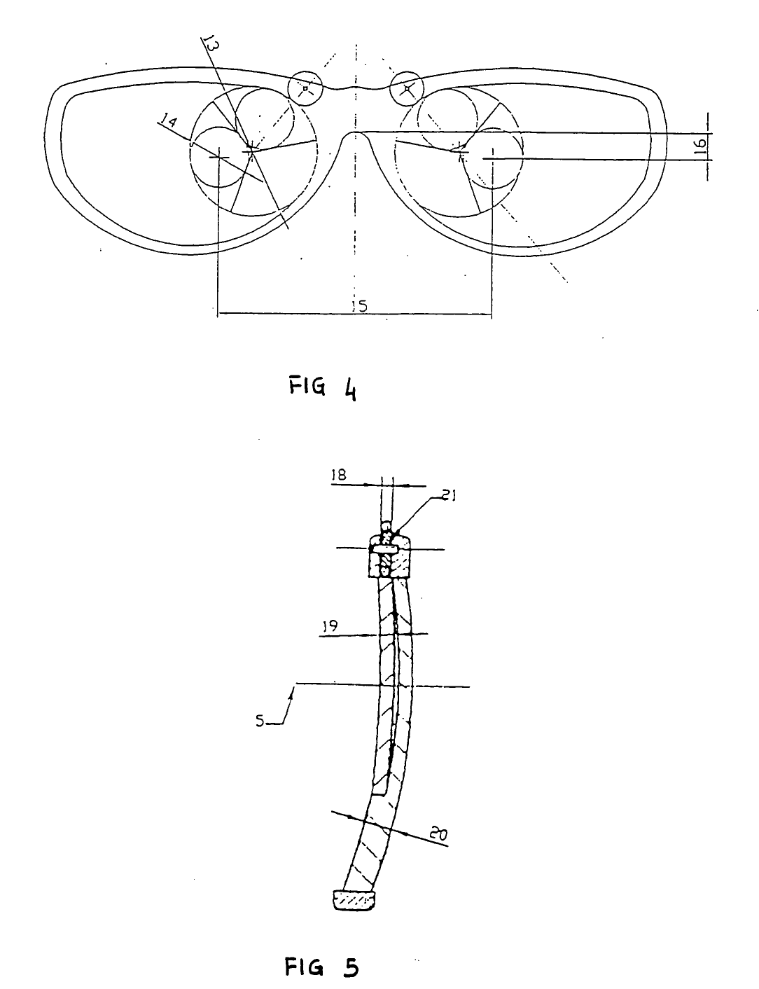

FIG. 4 shows an overall front view of the system, where: (15) is the distance between the pupils, with 58 mm≦(15)≦64 mm;

(16) is the distance between the pupil and the nose ridge, with 5 mm≦(16)≦7 mm;

(13) is the diameter of the lens, with areas of different strengths, (13) being changeable according to the different frames;

(14) is the diameter of the surfaces with a different strenghts, where (14) changes according to the various frames;

(17) is the diameter of the control system.

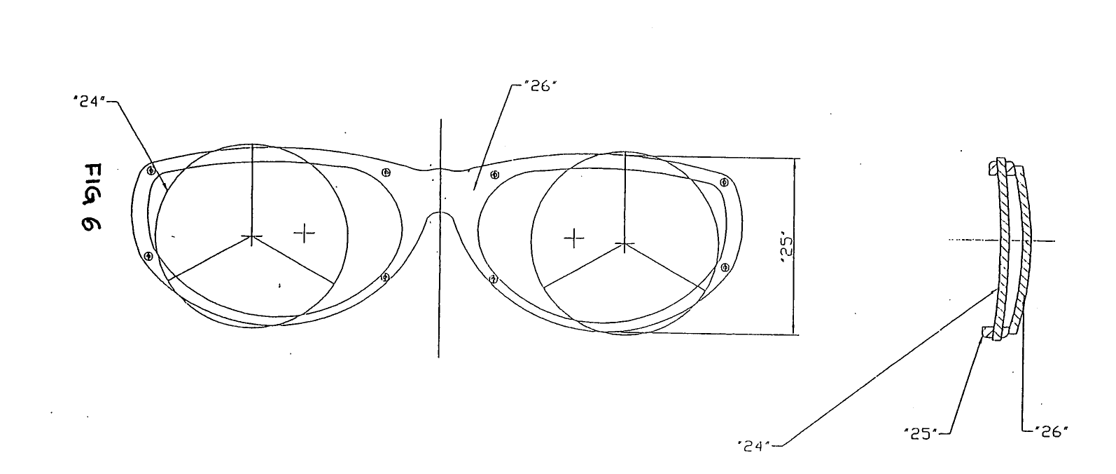

FIG. 5 shows a magnified view of the A-A section of FIG. 4, where:

(18) is the thickness of the control system, with (18)=2 mm;

(19) is the thickness of the corrective lens set, with (19)=2 mm;

(20) is the total thickness of the lens—corrective lens set, with (20)=4 mm;

(21) is the spindle with which the motor (22) is perfectly coupled.

Referring to the drawing the frame (1), which is mounted with fixed front lens (23), features a rotating mechanical movement.

By applying a slight pressure with the fingertip the motor (22), coupled with the spindle (21), starts rotating.

This assembly is housed inside a special cavity in the frame (1).

The motor transfer the motion, by friction, to the corrective lens (9) housed behind the fixed lens (23).

By impressing a certain rotation to the motor (22) this movement is transferreeid to the corrective lens (9), in a measure depending on the transmission ratio between the motor (22) and the lens (9).

A consequence of this principle is an alteration of the viewing conditions.

Experts in this field will notice that, thanks to the friction device, both close-range and distant focusing become practical, comfortable and easy to achieve, with a low impact on appearance.

To achieve the same purpose the system also envisages a corrective system easy to manufacture and apply: the corrective lens (24) is slightly larger than the lens mounted in the frame inside which it is housed. On the top and bottom of the frame (1) there are slots (27) through which projects parts of the corrective lens (24), therefore, the person wearing the glasses can directly rotate the lens, thus placing one of the three round sections (28) of varying strength in line with the pupillary axis. The slots (27) also have the function of guiding the corrective lens (24).

Lastly, the fixed lens (26) may be fastened to the front of the frame (1) by means of miniature screws (29).

Besides this embodiment the invention also includes all the possible variations.

The technical and geometric features of the invention are detailed in the drawing as follows:

FIG. 6 shows a fornt view and relative cross-section, where:

(30) is the corrective lens housed in the frame;

(31) are the vertical dimensions of the frame, where (30)>(31).

1- Device for the rotary sliding of corrective lens for correcting refractive defects at close range and for reducing eye strain caused by excessive visual stress suffered by videoterminal operators and other work/leisure activities, comprising fixed front lens (23) and corrective lens (9) featuring three refractive areas of varying strengths (10), (11) and (12) respectively, which may be changed by a mechanical and electromechanical means housed inside the frame (1) to suit and adapt to the visual conditions of the operator exposed to light radiation from the monitor screen.

2- A device as claimed in claim 1 apllied to the mechanical frame (1) comprising fixed front lens (23), a motor (22) coupled with a spindle (21), suitably recessed the frame (1), capable of transferring the motion, by friction, to the corrective lens (9), featuring three differeing refractive areas (10), (11) and (12), housed in the frame behind the fixed front lens (23).

3- A device as claimed in claim 1 and claim 2 wherein, by means of the pressure of a fingertip on the motor (22) coupled with the spindle (21), the former transfers the motion, by friction, to the corrective lens (9), Featuring three different refractive areas (10), (11) and (12), housed in the frame behind the fixed lens (23), thus resulting in an alteration of the visual conditions by virtue of the amount of motion the motor (22) transfers to the corrective lens (9), featuring three different refractive areas (10), (11) and (12).

4- A device as claimed in the foregoing claims wherein, by means of a controlled pressure on the motor (22) coupled with the spindle (21), occur the transfer by friction of the motion

5- Device for sliding/rotating corrective lens for correcting refractive defects at close range and for reducing eye strain caused by excessive visual stress suffered by videoterminal operators and other work/leisure activities, comprising fixed front lens (26) and corrective lens (24) featuring three round areas with differing degree of refraction, which can be directly adjusted by rotating the lens (24) housed inside the frame (25)
